(19) United States
(12) Patent Application Publication
(10) Pub. No.: US 2024/0104197 A1
(43) Pub. Date: Mar. 28, 2024

(54) SYSTEMS, METHODS, AND MEDIA FOR PROTECTING APPLICATION PROGRAMMING INTERFACES

(71) Applicant: McAfee, LLC, San Jose, CA (US)

(72) Inventor: Wenfeng Yu, Shenzhen (CN)

(21) Appl. No.: 18/090,279

(22) Filed: Dec. 28, 2022

Related U.S. Application Data
(63) Continuation of application No. PCT/CN2022/121971, filed on Sep. 28, 2022.

(51) Int. Cl. G06F 21/54; G06F 21/60

(52) U.S. Cl. CPC G06F 21/54; G06F 21/602

(57) ABSTRACT

Mechanisms for protecting an application programming interface (API) are provided. The mechanisms include: receiving a combined API message containing sensor data from an API client and an API message; separating the sensor data and the API message; classifying the sensor data; determining that the API message is not to be blocked based on the classifying; and processing the API message. In some embodiments, the mechanisms further include preparing the sensor data for classification. In some embodiments, preparing the sensor data for classification comprises formatting the sensor data as an image. In some embodiments, classifying the sensor data comprises classifying the sensor data using a convolutional neural network (CNN). In some embodiments, the CNN is a ResNet CNN. In some embodiments, separating the sensor data and the API message comprises removing the sensor data from a header of the API message.

### CROSS-REFERENCE TO RELATED APPLICATIONS

This application is a continuation of International Patent Application No. PCT/CN2022/121971, filed Sep. 28, 2022, which is hereby incorporated by reference herein in its entirety.

### BACKGROUND

Application programming interfaces (APIs, each an API) are widely used to enable different pieces of software to communicate with each other. For example, APIs are critical components in mobile device applications (commonly referred to as “apps”) that allow these applications to communicate with server applications via the Internet.

Nefarious actors frequently use automated tools, scripts, and/or other mechanisms to find vulnerabilities in APIs so that those actors can misuse the APIs.

Accordingly, new mechanisms for protecting application programming interfaces are desirable.

### SUMMARY

In accordance with some embodiments, mechanisms (which can include systems, methods, and media) for protecting application programming interfaces are provided.

In some embodiments, systems for protecting an application programming interface (API) are provided, the systems comprising: a memory; and at least one hardware processor that is coupled to the memory and configured to at least: receive a combined API message containing sensor data from an API client and an API message; separate the sensor data and the API message; classify the sensor data; determine that the API message is not to be blocked based on the classifying; and process the API message. In some of these embodiments, the at least one hardware processor is further configured to at least prepare the sensor data for classification. In some of these embodiments, preparing the sensor data for classification comprises formatting the sensor data as an image. In some of these embodiments, classifying the sensor data comprises classifying the sensor data using a convolutional neural network (CNN). In some of these embodiments, the CNN is a ResNet CNN. In some of these embodiments, separating the sensor data and the API message comprises removing the sensor data from a header of the API message. In some of these embodiments, the sensor data in the combined API message is timestamped and encrypted.

In some embodiments, methods for protecting an application programming interface (API) are provided, the methods comprising: receiving a combined API message containing sensor data from an API client and an API message; separating the sensor data and the API message; classifying the sensor data; determining that the API message is not to be blocked based on the classifying; and processing the API message. In some of these embodiments, the methods further comprise preparing the sensor data for classification. In some of these embodiments, preparing the sensor data for classification comprises formatting the sensor data as an image. In some of these embodiments, classifying the sensor data comprises classifying the sensor data using a convolutional neural network (CNN). In some of these embodiments, the CNN is a ResNet CNN. In some of these embodiments, separating the sensor data and the API message comprises removing the sensor data from a header of the API message. In some of these embodiments, the sensor data in the combined API message is timestamped and encrypted.

In some embodiments, non-transitory computer-readable media containing computer executable instructions that, when executed by a processor, cause the processor to perform a method for protecting an application programming interface (API) are provided, the method comprising: receiving a combined API message containing sensor data from an API client and an API message; separating the sensor data and the API message; classifying the sensor data; determining that the API message is not to be blocked based on the classifying; and processing the API message. In some of these embodiments, the method further comprises preparing the sensor data for classification. In some of these embodiments, preparing the sensor data for classification comprises formatting the sensor data as an image. In some of these embodiments, classifying the sensor data comprises classifying the sensor data using a convolutional neural network (CNN). In some of these embodiments, the CNN is a ResNet CNN. In some of these embodiments, separating the sensor data and the API message comprises removing the sensor data from a header of the API message. In some of these embodiments, the sensor data in the combined API message is timestamped and encrypted.

### BRIEF DESCRIPTION OF THE DRAWINGS

FIG. 1 shows an example of an architecture of interconnected components that can be used in accordance with some embodiments.

FIG. 2 shows an example of hardware that can be used for certain of the components shown in FIG. 1 in accordance with some embodiments.

FIG. 3 show an example of a process for protecting application programming interfaces in accordance with some embodiments.

### DETAILED DESCRIPTION

In accordance with some embodiments, mechanisms, which can include systems, methods, and media, for protecting application programming interfaces are provided. In some embodiments, these mechanisms can include: receiving a combined API message containing sensor data from an API client and an API message; separating the sensor data and the API message; classifying the sensor data; determining that the API message is not to be blocked based on the classifying; and processing the API message. In some of these embodiments, the mechanisms further comprise preparing the sensor data for classification. In some of these embodiments, preparing the sensor data for classification comprises formatting the sensor data as an image. In some of these embodiments, classifying the sensor data comprises classifying the sensor data using a convolutional neural network (CNN). In some of these embodiments, the CNN is a ResNet CNN. In some of these embodiments, separating the sensor data and the API message comprises removing the sensor data from a header of the API message. In some of these embodiments, the sensor data in the combined API message is timestamped and encrypted.

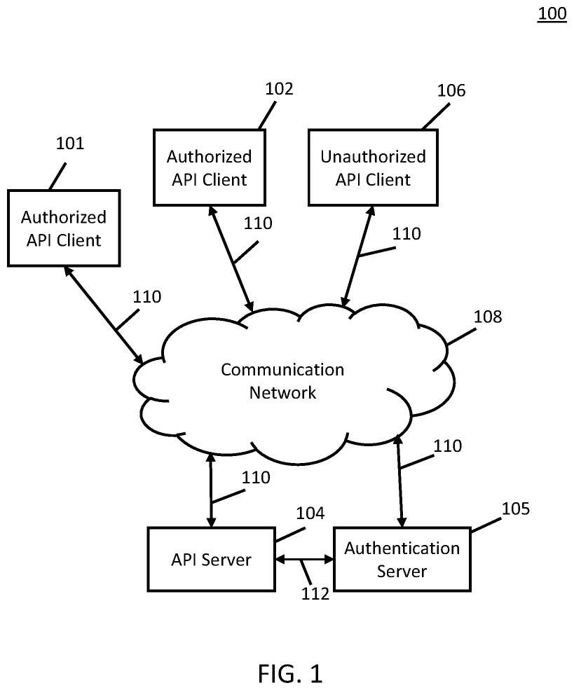

Turning to FIG. 1, an example 100 of an architecture of interconnected components that can be used in accordance with some embodiments of the disclosed subject matter is shown. As illustrated, architecture 100 can include authorized API clients 101 and 102, an API server 104, an authentication server 105, an unauthorized API client 106, and a communication network 108.

While it is not desirable to have an unauthorized API client in architecture 100, the reality is that one or more unauthorized API clients 106 may be present and may attempt to access the API of API server 104

Although particular numbers of particular devices are illustrated in FIG. 1, any suitable number(s) of each device shown, and any suitable additional or alternative devices, can be used in some embodiments. For example, one or more additional devices, such as servers, computers, routers, networks, printers, cameras, Internet-of-Things devices, etc., can be included in some embodiments. As another example, any suitable number of authorized API clients (including only one) can be included in some embodiments. As yet another example, any suitable number of unauthorized API clients (including only one) can be included in some embodiments. As still another example, any suitable number of API servers (including only one) can be included in some embodiments. As yet another example, any suitable number of authentication servers (including only one) can be included in some embodiments. In some embodiments, an API server and an authentication server can be combined into one device.

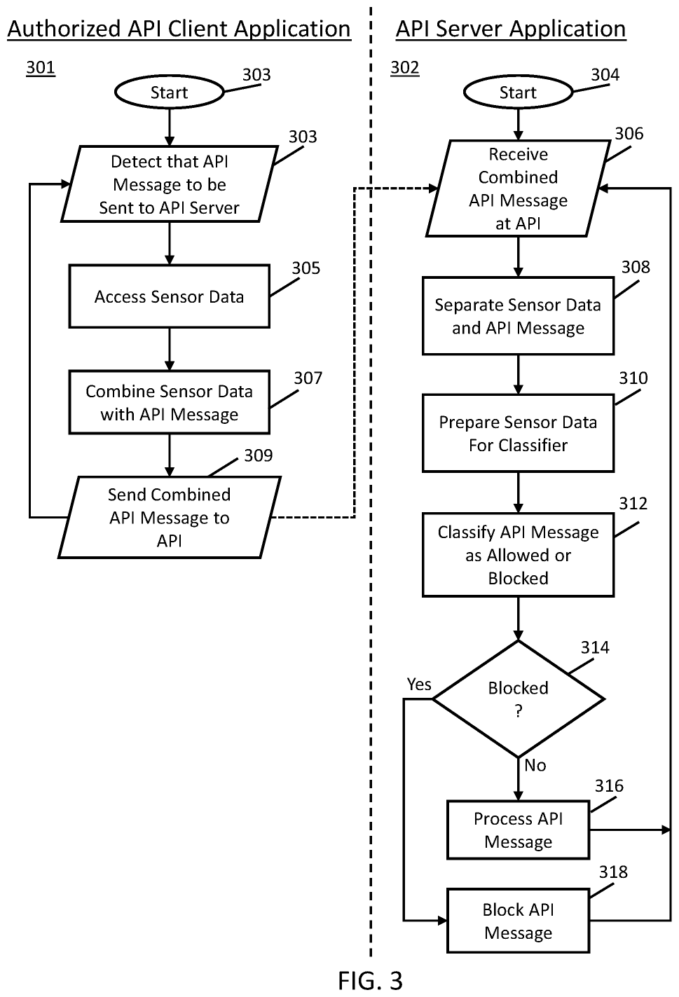

Authorized API clients 101 and 102 can be any suitable API clients that are authorized to access API server 104, in some embodiments. For example, in some embodiments, authorized API clients 101 and 102 can be mobile phones, tablet computers, laptop computers, desktop computers, smart watches, smart appliances, navigation devices, entertainment devices, Internet-of-Things (IoT) devices, and/or any other device capable of performing some or all of the functions described below in connection with portion 301 of FIG. 3 below.

Unauthorized API client 106 can be any suitable API client that is not authorized to access API server 104, in some embodiments. For example, in some embodiments, unauthorized API client 106 can be a mobile phone, a tablet computer, a laptop computer, a smart watch, a desktop computer, a smart appliance, a navigation device, an entertainment device, an Internet-of-Things (IoT) device, and/or any other device capable of communicating with the API of server 104 and attempting to find vulnerabilities in the API.

API server 104 can be any suitable device capable of providing an API for use by authorized API clients 101 and 102. For example, in some embodiments, API server 104 can be a server that receives and responds to communications from authorized API clients 101 and/or 102.

Authentication server 105 can be any suitable device capable of authenticating attempts to access the API of API server 104. For example, authentication server 105 can be a server that performs at least some of the functions described below in connection with portion 302 of FIG. 3 below. In some embodiments, authentication server 105 can additionally authenticate attempts to access one or more APIs of API servers other than API server 104.

Communication network 108 can be any suitable combination of one or more wired and/or wireless networks in some embodiments. For example, in some embodiments, communication network 108 can include any one or more of the Internet, a mobile data network, a satellite network, a local area network, a wide area network, a telephone network, a cable television network, a WiFi network, a WiMax network, and/or any other suitable communication network.

Authorized API clients 101 and 102, unauthorized API client 106, API server 104, and authentication server 105 can be connected by one or more communications links 110 to communication network 108. These communications links can be any communications links suitable for communicating data among authorized API clients 101 and 102, unauthorized API client 106, API server 104, authentication server 105, and communication network 212, such as network links, dial-up links, wireless links, hard-wired links, routers, switches, any other suitable communications links, or any suitable combination of such links.

API server 104 and authentication server 105 can be connected by one or more communications links 112. These communications links can be any communications links suitable for communicating data among API server 104 and authentication server 105, such as network links, dial-up links, wireless links, hard-wired links, routers, switches, any other suitable communications links, or any suitable combination of such links.

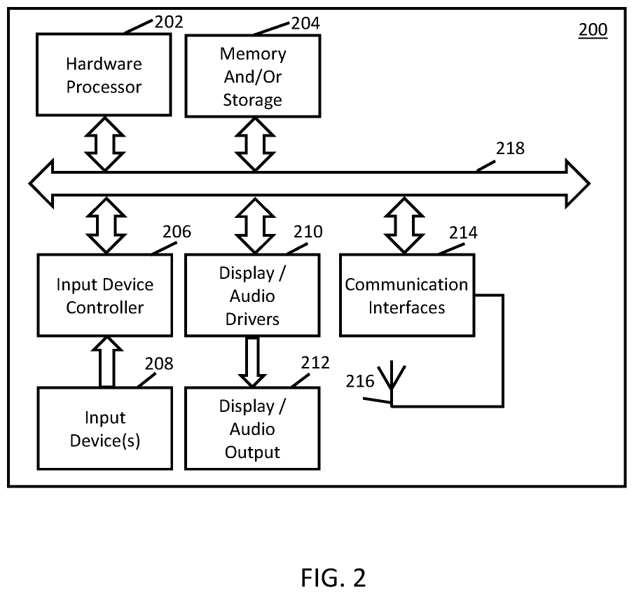

Authorized API clients 101 and 102, unauthorized API client 106, API server 104, and authentication server 105 can be implemented using any suitable hardware in some embodiments. For example, in some embodiments, authorized API clients 101 and 102, unauthorized API client 106, API server 104, and authentication server 105 can be implemented using any suitable general-purpose computer or special-purpose computer(s). For example, authorized API clients 101 and 102 can be implemented using a special-purpose computer, such as a mobile phone. Any such general-purpose computer or special-purpose computer can include any suitable hardware. For example, as illustrated in example hardware 200 of FIG. 2, such hardware can include a hardware processor 202, memory and/or storage 204, an input device controller 206, an input device 208, display/audio drivers 210, display and audio output circuitry 212, communication interface(s) 214, an antenna 216, and a bus 218.

Hardware processor 302 can include any suitable hardware processor, such as a microprocessor, a micro-controller, digital signal processor(s), dedicated logic, and/or any other suitable circuitry for controlling the functioning of a general-purpose computer or a special purpose computer in some embodiments.

Memory and/or storage 204 can be any suitable memory and/or storage for storing programs, data, and/or any other suitable information in some embodiments. For example, memory and/or storage 204 can include random access memory, read-only memory, flash memory, hard disk storage, optical media, and/or any other suitable memory.

Input device controller 206 can be any suitable circuitry for controlling and receiving input from input device(s) 208 in some embodiments. For example, input device controller 206 can be circuitry for receiving input from an input device 208, such as a touch screen, from one or more buttons, from a voice recognition circuit, from a microphone, from a camera, from an optical sensor, from an accelerometer, from a magnetic field sensor, from a proximity sensor, from a touch pressure sensor, from a touch size sensor, from a temperature sensor, from a near field sensor, from an orientation sensor, and/or from any other type of input device.

Display/audio drivers 210 can be any suitable circuitry for controlling and driving output to one or more display/audio output circuitries 212 in some embodiments. For example, display/audio drivers 210 can be circuitry for driving one or more display/audio output circuitries 212, such as an LCD display, a speaker, an LED, or any other type of output device.

Communication interface(s) 214 can be any suitable circuitry for interfacing with one or more communication networks, such as network 108 as shown in FIG. 1. For example, interface(s) 214 can include network interface card circuitry, wireless communication circuitry, and/or any other suitable type of communication network circuitry.

Antenna 216 can be any suitable one or more antennas for wirelessly communicating with a communication network in some embodiments. In some embodiments, antenna 216 can be omitted when not needed.

Bus 218 can be any suitable mechanism for communicating between two or more components 202, 204, 206, 210, and 214 in some embodiments.

Any other suitable components can additionally or alternatively be included in hardware 200 in accordance with some embodiments.

Turning to FIG. 3, an example 300 of a process for protecting application programming interfaces in accordance with some embodiments is shown. As shown, this process includes portion 301 (left of the vertical dashed line) and portion 302 (right of the vertical dashed line). Portion 301 can execute in an authorized API client, such as authorized API clients 101 and 102, in some embodiments. Portion 302 can execute in API server 104 and/or authentication server 105, in some embodiments (e.g., some of the blocks of portion 302 can be performed in API server 104 and other blocks of portion 302 can be performed in authentication server 105).

As illustrated in FIG. 3, portion 301 of process 300 can begin at 303 and portion 302 of process 300 can begin at 304.

Next, at 303, process 300 can detect that an API message is about to be sent from the authorized API client to the API server. This determination can be made in any suitable manner. For example, in some embodiments, this determination can be made in response to the process detecting that a new API message has been put in an outbound queue of API messages.

The term “API message” as used herein should be understood to be any type of signals, data, information, code, and/or anything else that may be sent to an API. In some embodiments, process 300 can operate only on a subset of API messages. For example, in some embodiments, process 300 can operate only on API messages of a certain type.

Then, at 305, process 300 can access sensor data related to the authorized API client. Any suitable sensor data can be accessed. For example, in some embodiments, sensor data can include orientation data, accelerometer data, magnetic data, proximity data, touch pressure data, touch size data, camera data (e.g., image and/or video), sound data (e.g., sound captured from a microphone), and/or any other suitable data. In some embodiments, this data can be received from an input device (e.g., input device 128) of an authorized API client (e.g., authorized API client 101 or 102). In some embodiments, this data can be collected for a period of time in advance of detecting that an API message is about to be sent at 303, and/or this data can be collected for a period of time after detecting that an API message is about to be sent at 303. The sensor data access at 305 can be selected to reflect that a human user is holding and/or interacting with the authorized API client.

At 307, process can next combine the sensor data with the API message. The sensor data can be combined with the API message in any suitable manner. For example, in some embodiments, the sensor data can be placed in a header and/or a body of the API message.

In some embodiments, as part of combining the sensor data with the API message, the sensor data can be processed in any suitable manner and the processed sensor data can then be combined with the API message. For example, in some embodiments, the sensor data can be processed by removing certain portions of the sensor data from the sensor data. As another example, in some embodiments, the sensor data can be processed by encoding, compressing, timestamping, and/or encrypting the sensor data.

Next, at 309, process 300 can send the combined API message to the API of the API server. The combined API message can be sent to the API in any suitable manner. For example, in some embodiments, the combined API message can be sent to the API as an http get request or as an http post request.

Then, at 306, process 300 can received the combined API message. The combined API message can be received in any suitable manner. For example, in some embodiments, the combined API message can be received at 306 at the API of the API server as an http get request. As another example, in some embodiments, the combined API message can be received at 306 at the authentication server as an http get request or an http post request after being forward to the authentication server by the API server.

At 308, process 300 can then separate the sensor data from the API message. The sensor data can be separated from the API message in any suitable manner. For example, in some embodiments, the sensor data can be separated from the API message by being removed from a header of the combined API message.

In some embodiments, as part of separating the sensor data from the API message, the sensor data can be processed in any suitable manner. For example, in some embodiments, the sensor data can be processed by decoding, decompressing, and/or decrypting the sensor data.

Next, at 310, process 300 can prepare the sensor data for analysis by a classifier. The sensor data can be prepared in any suitable manner. For example, in some embodiments, preparing the sensor data can include placing the sensor data in a certain format. More particularly, for example, in some embodiments, preparing the sensor data can include placing the sensor data in any suitable image format (e.g., such as a bitmap). As another example, in some embodiments, preparing the sensor data can include hashing the sensor data and/or storing the sensor data in any suitable structure (e.g., a database, a bloom filter, and/or any other suitable structure for comparing two pieces of sensor data to determine if they are identical or almost identical).

Then, at 312, process 300 can classify the API message as either allowed or blocked. This classification can be performed in any suitable manner using any suitable classifier. For example, in some embodiments, the classification can be performed by a machine learning mechanism and/or by an artificial intelligence mechanism. More particularly, for example, this classification can be performed by a convolutional neural network (CNN) (e.g., such as ResNet or any other suitable CNN).

In some embodiments, when a machine learning mechanism and/or an artificial intelligence mechanism (such as a CNN) is used to classify the sensor data, the mechanism can have been trained in any suitable manner using any suitable data. For example, in some embodiments, the mechanism can be trained to recognize when a human user is operating an authorized API client using any suitable sensor data, such as orientation data, accelerometer data, magnetic data, proximity data, touch pressure data, touch size data, camera data (e.g., image and/or video), sound data (e.g., sound captured from a microphone), and/or any other suitable sensor data.

In some embodiments, classifying at 312 can including checking sensor data against previously received sensor data to identify replay data. For example, the sensor data (or a hash of the same) can be compared to previously received sensor data represented in any suitable structure (e.g., a database, a bloom filter, and/or any other suitable structure for comparing two pieces of sensor data to determine if they are identical or almost identical). As another example, sensor data in bit map format can be compared to previously received sensor data, also in bit map format, to identify duplicate, or nearly duplicate sensor data.

At 314, process can determine if the API message is classified as being blocked. If not, process 300 can proceed to 316 and process the API message in any suitable manner and then loop back to 306, in some embodiments. Otherwise, in some embodiments, process 300 can block the API message at 318 and then loop back to 306. In some embodiments, at 318, the process can return a message to the API client that sent the combined API message indicating that the API message was blocked. In some embodiments, at 318, the process can NOT return a message to the API client that sent the combined API message indicating that the API message was blocked.

While process 300 has been described herein as a constant flow from portion 1 at 309 to portion 2 at 306, it should be apparent that portion 301 and portion 302 can run independently, and that portion 302 may receive combined API messages from multiple different authorized API clients and unauthorized API clients. In some instances, the combined API message received at 306 will have been generated by an unauthorized API client, such as unauthorized API client 106 of FIG. 1. The combined API message may have been generated to contain sensor data that is intended to make the mechanism used to classify the API message classify the API message as not blocked. However, the mechanism can be configured and/or trained to minimize the number of API messages that come from unauthorized API clients and that are not blocked.

It should be understood that at least some of the above-described blocks of the process of FIG. 3 can be executed or performed in any order or sequence not limited to the order and sequence shown in and described in the figure. Also, some of the above blocks of the process of FIG. 3 can be executed or performed substantially simultaneously where appropriate or in parallel to reduce latency and processing times. Additionally or alternatively, some of the above described blocks of the process of FIG. 3 can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

As can be seen, the mechanisms described herein can be used to enhance security of an API of a computing device. In this way, confidential information, such as personally identifiable information, credit card information, bank information, trade secrets, accounting information, etc., can be protected from theft, damage, etc. by malicious actors that might otherwise gain access to the API.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for protecting an application programming interface (API), comprising:
a memory; and
at least one hardware processor that is coupled to the memory and configured to at least:
receive a combined API message containing sensor data from an API client and an API message;
separate the sensor data and the API message;
classify the sensor data;
determine that the API message is not to be blocked based on the classifying; and
process the API message.

2. The system of claim 1, wherein the at least one hardware processor is further configured to at least prepare the sensor data for classification.

3. The system of claim 2, wherein preparing the sensor data for classification comprises formatting the sensor data as an image.

4. The system of claim 1, wherein classifying the sensor data comprises classifying the sensor data using a convolutional neural network (CNN).

5. The system of claim 4, wherein the CNN is a ResNet CNN.

6. The system of claim 1, wherein separating the sensor data and the API message comprises removing the sensor data from a header of the API message.

7. The system of claim 1, wherein the sensor data in the combined API message is timestamped and encrypted.

8. A method for protecting an application programming interface (API), comprising:
receiving a combined API message containing sensor data from an API client and an API message;
separating the sensor data and the API message;
classifying the sensor data;
determining that the API message is not to be blocked based on the classifying; and
processing the API message.

9. The method of claim 8, further comprising preparing the sensor data for classification.

10. The method of claim 9, wherein preparing the sensor data for classification comprises formatting the sensor data as an image.

11. The method of claim 8, wherein classifying the sensor data comprises classifying the sensor data using a convolutional neural network (CNN).

12. The method of claim 11, wherein the CNN is a ResNet CNN.

13. The method of claim 8, wherein separating the sensor data and the API message comprises removing the sensor data from a header of the API message.

14. The method of claim 8, wherein the sensor data in the combined API message is timestamped and encrypted.

15. A non-transitory computer-readable medium containing computer executable instructions that, when executed by a processor, cause the processor to perform a method for protecting an application programming interface (API), the method comprising:
receiving a combined API message containing sensor data from an API client and an API message;
separating the sensor data and the API message;
classifying the sensor data;
determining that the API message is not to be blocked based on the classifying; and
processing the API message.

16. The non-transitory computer-readable medium of claim 15, wherein the method further comprises preparing the sensor data for classification.

17. The non-transitory computer-readable medium of claim 16, wherein preparing the sensor data for classification comprises formatting the sensor data as an image.

18. The non-transitory computer-readable medium of claim 15, wherein classifying the sensor data comprises classifying the sensor data using a convolutional neural network (CNN).

19. The non-transitory computer-readable medium of claim 18, wherein the CNN is a ResNet CNN.

20. The non-transitory computer-readable medium of claim 15, wherein separating the sensor data and the API message comprises removing the sensor data from a header of the API message.

21. The non-transitory computer-readable medium of claim 15, wherein the sensor data in the combined API message is timestamped and encrypted.
